(19) United States
(12) Patent Application Publication
(10) Pub. No.: US 2010/0046347 A1
(43) Pub. Date: Feb. 25, 2010

(54) OPTICAL SCANNING DEVICE

(75) Inventors: Teunis Willem Tukker, Eindhoven (NL); Joris Jan Vrehen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,012

(22) PCT Filed: Jan. 18, 2006
(86) PCT No.: PCT/IB06/50190

§ 371 Date: Jul. 16, 2007

(30) Foreign Application Priority Data
Jan. 19, 2005 (EP) 05100288.9

(51) Int. Cl. G11B 7/135

(52) U.S. Cl. 369/112.23; G9B/7.112

(57) ABSTRACT

An optical scanning device for scanning optical record carriers, the optical record carriers including a first optical record carrier, a second optical record carrier and a third optical record carrier, the scanning device including a radiation source system (7) for producing first, second and third radiation beams for scanning said first, second and third record carriers, respectively, in first, second and third scanning modes, said first, second and third radiation beams having different predetermined wavelengths, the scanning device comprising an objective lens and an optical compensator, the optical compensator having a non-periodic phase structure through which each of said first, second and third radiation beams are arranged to pass, said non-periodic phase structure including a plurality of stepped annular zones separated by steps, the zones forming a non-periodic radial pattern, the stepped annular zones introducing first, second and third different wavefront modifications into at least part of the first, second and third radiation beams, respectively, characterized in that said objective lens is arranged to apply a focus offset when scanning said first record carrier, which focus offset is arranged to provide a phase modification which, in combination with said optical compensator, compensates spherical aberration in the first radiation beam.

### FIELD OF THE INVENTION

This invention relates to an optical scanning device for scanning optical record carriers, the optical record carriers including a first optical record carrier, a second optical record carrier and a third optical record carrier, the scanning device including a radiation source system for producing first, second and third radiation beams for scanning said first, second and third record carriers, respectively, in first, second and third scanning modes, said first, second and third radiation beams having different predetermined wavelengths.

### BACKGROUND OF THE INVENTION

The field of data storage using optical record carriers is currently an intensively researched area of technology. Many such optical record carrier formats exist including compact discs (CD), conventional digital versatile discs (DVD), Blu-ray discs (BD) and high definition digital versatile discs (HDDVD). These formats are available in different types including read-only versions (e.g. CD-ROM/DVD-ROM/BD-ROM), recordable versions (e.g. CD-R/DVD-R/BD-R), re-writeable versions (e.g. CD-RW/DVD-RW/BD-RE) and audio versions (e.g. CD-A). For scanning the different formats of optical record carrier it is necessary to use a radiation beam having a different wavelength. This wavelength is approximately 785 nm for scanning a CD, approximately 660 nm for scanning a DVD (note that the officially specified wavelength is 650 nm, but in practice it is often close to 660 nm) and approximately 405 nm for scanning a BD.

Different formats of optical disc are capable of storing different maximum quantities of data. This maximum quantity is related to the wavelength of the radiation beam, which is necessary to scan the disc and a numerical aperture (NA) of the objective lens. Scanning, when referred to herein, can include reading and/or writing of data on the disc.

The data on an optical disc is stored on an information layer. The information layer of the disc is protected by a cover layer, which has a predetermined thickness. Different formats of optical disc have a different thickness of the cover layer, for example the cover layer thickness of CD is approximately 1.2 mm, DVD is approximately 0.6 mm and BD is approximately 0.1 mm. When scanning an optical disc of a certain format, the radiation beam is focused to a point on the information layer. As the radiation beam passes through the cover layer of the disc a spherical aberration is introduced into the radiation beam. An amount of introduced spherical aberration depends on the thickness of the cover layer and the wavelength of the radiation beam. Prior to reaching the cover layer of the disc the radiation beam needs to already possess a certain spherical aberration such that in combination with the spherical aberration introduced by the cover layer, the radiation beam may be correctly focused on the information layer of the disc. For scanning different discs with different cover layer thicknesses, the radiation beam needs to possess a different spherical aberration prior to reaching the cover layer. This ensures correct focusing of the radiation beam on the information layer.

As a result when using a single objective to scanning all discs, different amount of spherical aberration for each disc type must be generated by the objective in order to cope with the difference in cover layer thickness.

An article by B. H. W. Hendriks, J. E. de Vries, and H. P. Urbach entitled “Application of non-periodic phase structures in optical systems”, Applied Optics vol. 40, pp 6548-6560 (2001) describes a non-periodic phase structure (NPS) which is capable of rendering a DVD objective lens compatible with CD scanning.

International patent application WO 03/060891 describes an optical scanning device for scanning an information layer of three different optical record carriers using, respectively, three different radiation beams. Each radiation beam has a polarisation and a different wavelength. The device includes an objective lens having a diffractive part, which includes birefringent material. The diffractive part diffracts the radiation beams such that the beam with the shortest wavelength has an introduced phase change modulo 27π of substantially zero for the shortest wavelength. The diffractive part diffracts at least one of the other radiation beams into a positive first order.

International patent application WO 03/060892 describes an optical scanning device for scanning an information layer of three different optical record carriers using, respectively, three different radiation beams. Each radiation beam has a polarisation and a different wavelength. The device includes an objective lens and a non-periodic phase structure (NPS) for compensating a wavefront aberration of one or two of the radiation beams. The phase structure includes birefringent material and has a non-periodic stepped profile.

U.S. Pat. No. 6,687,037 describes an optical scanning device for scanning optical record carriers with radiation beams of two different wavelengths. The device includes an objective lens and a diffractive element having a stepped profile, which approximates a blazed diffraction grating. The diffractive element selects a zeroth diffraction order for the radiation beam of the shortest wavelength, and selects a first order for the other radiation beam.

For two mode objective lenses like a DVD/CD compatible lens NPSs or diffractive structures can be used with a lens designed for one mode to correct the spherical aberration in the other mode. In case of the three-mode objective lens like a BD/DVD/CD compatible lens the demands for such an NPS or diffractive structure are very severe since the structure has to compensate different amount of spherical aberration in two modes, while leaving the third mode unaffected. It is possible, by choosing specific multiples of a basic step height, to compensate different amounts of spherical aberration in the two modes. However, one main disadvantage of this solution is the triple mode compatibility leads to high step heights in the NPS. As a result, the wavefront aberration dependency on the wavelength is large.

It would therefore be desirable to reduce the wavelength dependency of the wavefront modification provided by an NPS which provides three wavelength, or more, compatibility.

### SUMMARY OF THE INVENTION

In accordance with the present invention there is provided an optical scanning device for scanning optical record carriers, the optical record carriers including a first optical record carrier, a second optical record carrier and a third optical record carrier, the scanning device including a radiation source system (7) for producing first, second and third radiation beams for scanning said first, second and third record carriers, respectively, in first, second and third scanning modes, said first, second and third radiation beams having different predetermined wavelengths,

the scanning device comprising an objective lens and an optical compensator,

the optical compensator having a non-periodic phase structure through which each of said first, second and third radiation beams are arranged to pass, said non-periodic phase structure including a plurality of stepped annular zones separated by steps, the zones forming a non-periodic radial pattern, the stepped annular zones introducing first, second and third different wavefront modifications into at least part of the first, second and third radiation beams, respectively,

characterized in that said objective lens is arranged to apply a focus offset when scanning said first record carrier, which focus offset is arranged to provide a phase modification which, in combination with said optical compensator, compensates spherical aberration in the first radiation beam.

The invention provides a solution for a multiple mode objective system, in which the step heights of the NPS used in an optical compensator can be reduced, thus reducing the wavelength-dependency of the operation of the NPS, and thus the optical scanning device as a whole.

The focus offset can be applied during design of the objective lens in an optical design program. During operation the servo electronics of the optical drive will focus the objective lens automatically to this defocused position, so no change in the electronic servo needs to be applied. The objective lens and NPS combination described in this invention has an optimum focusing distance which is shifted, preferably by at least 2 μm and more preferably by at least 5 μm with respect to the optimum focusing distance of the objective lens only, and the objective lens with NPS as was described in the prior art.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows schematically an optical scanning device in accordance with an embodiment of the present invention.

FIG. 2 shows schematically an optical system of the optical scanning device in accordance with an embodiment of the present invention.

FIG. 3 shows optical path differences in each of CD, DVD and BD modes, for a lens design in accordance with an embodiment of the invention.

FIG. 4 shows an optical path difference in CD mode, along with a corresponding NPS design, in accordance with the prior art.

FIG. 5 shows a remaining optical path difference, after compensation using the NPS design shown in FIG. 4, in CD mode.

FIG. 6 shows an optical path difference in CD mode, along with a corresponding NPS design, in accordance with an embodiment of the invention.

FIG. 7 shows a remaining optical path difference, after compensation using the NPS design shown in FIG. 6, in CD mode.

### DETAILED DESCRIPTION OF THE INVENTION

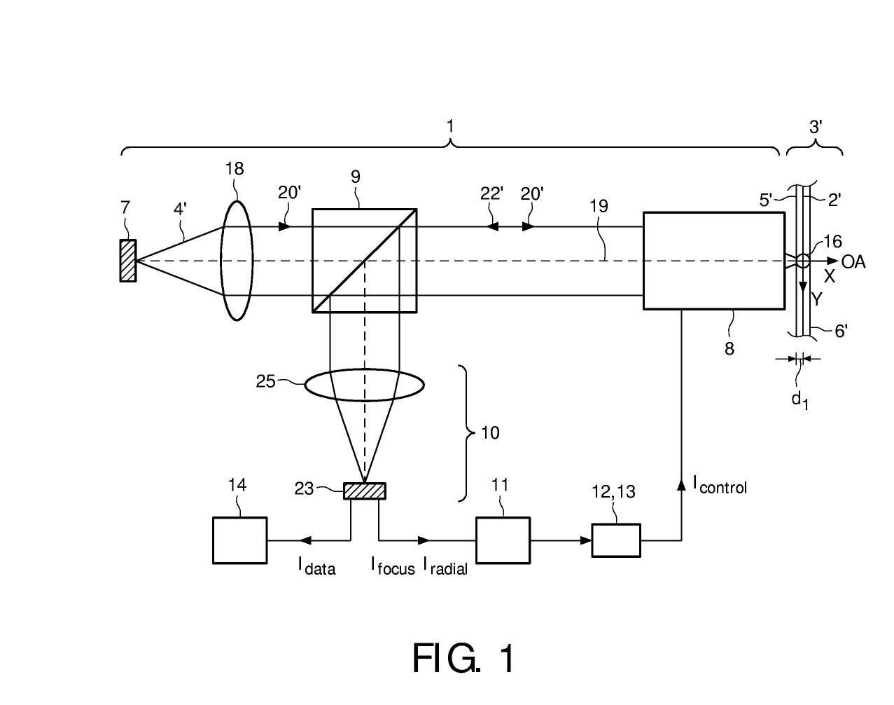

FIG. 1 shows schematically an optical scanning device for scanning first, second and third optical record carriers with a first, second and third, different, radiation beam, respectively. The first optical record carrier 3′ is illustrated and has a first information layer 2′ which is scanned by means of the first radiation beam 4′. The first optical record carrier 3′ includes a cover layer 5′ on one side of which the first information layer 2′ is arranged. The side of the information layer facing away from the cover layer 5′ is protected from environmental influences by a protective layer 6′. The cover layer 5′ acts as a substrate for the first optical record carrier 3′ by providing mechanical support for the first information layer 2′. Alternatively, the cover layer 5′ may have the sole function of protecting the first information layer 2′, while the mechanical support is provided by a layer on the other side of the first information layer 2′, for instance by the protective layer 6′ or by an additional information layer and cover layer connected to the uppermost information layer. The first information layer 2′ has a first information layer depth d₁ that corresponds to the thickness of the cover layer 5′. The second and third optical record carriers (not shown) have a second and a third, different, information layer depth d₂, d₃, respectively, corresponding to the thickness of the cover layer (not shown) of the second and third optical record carriers, respectively. The third information layer depth d₃ is less than the second information layer depth d₂, which is less than the first information layer depth d₁, i.e. d3<d2<d1. The first information layer 2′ is a surface of the first optical record carrier 3′. Similarly the second and third information layers (not shown) are surfaces of the second and third optical record carriers. That surface contains at least one track, i.e. a path to be followed by the spot of a focused radiation on which path optically readable marks are arranged to represent information. The marks may be, e.g., in the form of pits or areas with a reflection coefficient or a direction of magnetisation different from the surroundings. In the case where the first optical record carrier 3′ has the shape of a disc, the following is defined with respect to a given track: the “radial direction” is the direction of a reference axis, the X-axis, between the track and the centre of the disc and the “tangential direction” is the direction of another axis, the Y-axis, that is tangential to the track and perpendicular to the X-axis. In this embodiment the first optical record carrier 3′ is a compact disc (CD) and the first information layer depth d₁ is approximately 1.2 mm, the second optical record carrier is a conventional digital versatile disc (DVD) and the second information layer depth d₂ is approximately 0.6 mm, and the third optical record carrier is a Blu-ray™ disc (BD) and the third information layer depth d₃ is approximately 0.1 mm.

As shown in FIG. 1, the optical scanning device 1 has an optical axis OA and includes a radiation source system 7, a collimator lens 18, a beam splitter 9, an objective system 8 and a detection system 10. Furthermore, the optical scanning device 1 includes a servo circuit 11, a focus actuator 12, a radial actuator 13, and an information-processing unit 14 for error correction.

The radiation source system 7 is arranged for consecutively or simultaneously producing the first radiation beam 4′, the second radiation beam and/or the third, different, radiation beam (not shown in FIG. 1). For example, the radiation source 7 may comprise either a tunable semiconductor laser for consecutively supplying the radiation beams or three semiconductor lasers for simultaneously or consecutively supplying these radiation beams. The first radiation beam 4′ has a first predetermined wavelength λ₁ the second radiation beam 4″ has a second, different, predetermined wavelength λ₂, and the third radiation beam 4′″ has a third different predetermined wavelength λ₃. In this embodiment the third wavelength λ₃ is shorter than the second wavelength λ₂. The second wavelength λ₂ is shorter than the first wavelength λ₁. In this embodiment the first, second and third wavelength λ₁, λ₂, λ₃, respectively, is within the range of approximately 770 to 810 nm for λ₁, 640 to 680 nm for λ₂, 400 to 420 nm for λ₃ and preferably approximately 785 nm, 660 nm and 405 nm, respectively. The first, second and third radiation beams have a numerical aperture (NA) of approximately 0.5, 0.65 and 0.85 respectively.

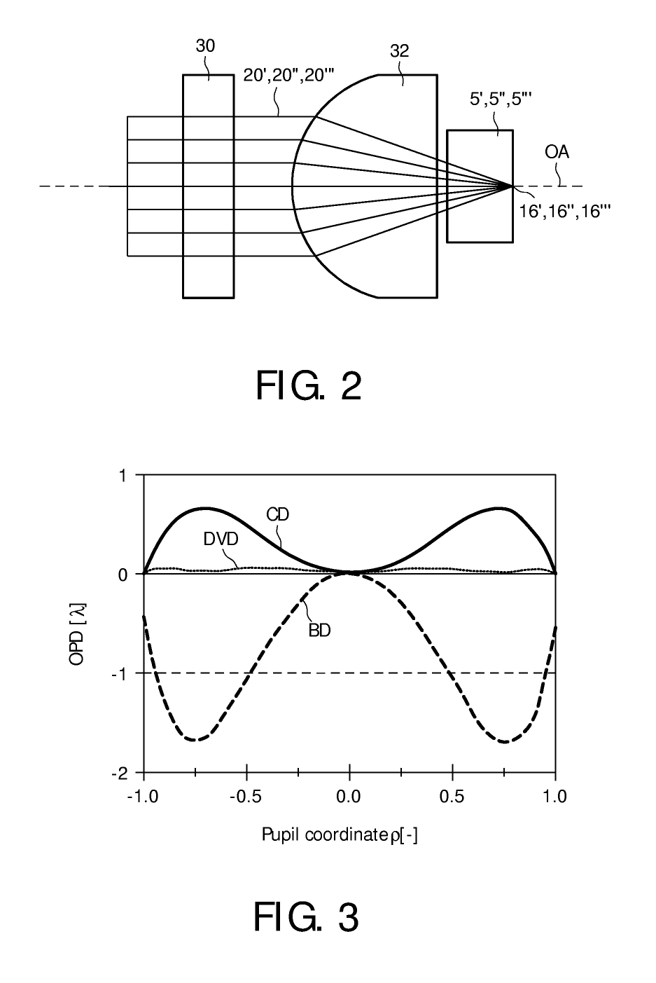

The collimator lens 18 is arranged on the optical axis OA for transforming the first radiation beam 4′ into a first substantially collimated beam 20′. Similarly, it transforms the second and third radiation beams into a second substantially collimated beam 20″ and a third substantially collimated beam 20′″ (illustrated in FIG. 2).

The beam splitter 9 is arranged for transmitting the first, second and third collimated radiation beams toward the objective system 8. Preferably, the beam splitter 9 is formed with a plane parallel plate that is tilted with an angle α with respect to the optical axis OA and, preferably, α=45°.

The objective system 8 is arranged to focus the first, second and third collimated radiation beams to a desired focal point on the first, second and third optical record carriers, respectively. The desired focal point for the first radiation beam is a first scanning spot 16′. The desired focal point for the second and third radiation beams are second and third scanning spots 16″, 16′″, respectively (shown in FIG. 2). Each scanning spot corresponds to a position on the information layer of the appropriate optical record carrier. Each scanning spot is preferably substantially diffraction limited and has a wave front aberration, which is less than 70 mλ.

During scanning, the first optical record carrier 3′ rotates on a spindle (not shown) and the first information layer 2′ is then scanned through the cover layer 5′. The focused first radiation beam 20′ reflects on the first information layer 2′, thereby forming a reflected first radiation beam which returns on the optical path of the forward converging focused first radiation beam provided by the objective system 8. The objective system 8 transforms the reflected first radiation beam to a reflected collimated first radiation beam 22′. The beam splitter 9 separates the forward first radiation beam 20′ from the reflected first radiation beam 22′ by transmitting at least a part of the reflected first radiation beam 22′ towards the detection system 10.

The detection system 10 includes a convergent lens 25 and a quadrant detector 23 which are arranged for capturing said part of the reflected first radiation beam 22′ and converting it to one or more electrical signals. One of the signals is an information signal I_{data}, the value of which represents the information scanned on the information layer 2′. The information signal I_{data} is processed by the information-processing unit 14 for error correction. Other signals from the detection system 10 are a focus error signal I_{focus} and a radial tracking error signal I_{radial}. The signal I_{focus} represents the axial difference in height along the optical axis OA between the first scanning spot 16′ and the position of the first information layer 2′. Preferably, this signal is formed by the “astigmatic method” which is known from, inter alia, the book by G. Bouwhuis, J. Braat, A. Huijser et al, entitled “Principles of Optical Disc Systems,” pp. 75-80 (Adam Hilger 1985) (ISBN 0-85274-785-3). A device for creating an astigmatism according to this focussing method is not illustrated. The radial tracking error signal I_{radial} represents the distance in the XY-plane of the first information layer 2′ between the first scanning spot 16′ and the centre of a track in the information layer 2′ to be followed by the first scanning spot 16′. Preferably, this signal is formed from the “radial push-pull method” which is known from, inter alia, the book by G. Bouwhuis, pages. 70-73.

The servo circuit 11 is arranged for, in response to the signals I_{focus} and I_{radial}, providing servo control signals I_{control} for controlling the focus actuator 12 and the radial actuator 13, respectively. The focus actuator 12 controls the position of a lens of the objective system 8 along the optical axis OA, thereby controlling the position of the first scanning spot 16′ such that it coincides substantially with the plane of the first information layer 2′. The radial actuator 13 controls the position of the lens of the objective system 8 along the X-axis, thereby controlling the radial position of the first scanning spot 16′ such that it coincides substantially with the centre line of the track to be followed in the first information layer 2′.

FIG. 2 shows schematically the objective system 8 of the optical scanning device. The objective system 8, in accordance with an embodiment of the present invention, is arranged to introduce first, second and third, different, wavefront modifications WM₁, WM₂, WM₃, into at least part of the first, second and third radiation beams 20′, 20″, 20′″, respectively.

The objective system 8 includes an optical compensator, which in this embodiment is in the form of a corrector plate 30, and an objective lens 32 which are both arranged on the optical axis OA. The objective lens 32 has an aspherical face facing in a direction away from the optical record carrier. The lens 32 is, in this example, formed of glass.

The corrector plate 30 includes a planar base substrate on which an NPS is formed. The NPS includes a series of annular zones of different heights, each separated by a discrete step of a controlled height.

In preferred embodiments, the zones of the NPS introduce a substantially constant phase across the zone and are selected such that, at the position of the step, the zone is substantially invisible to the wavelength of a selected one of the first, second and third radiation beams 20′, 20″, 20′″. That is to say, steps can be found which add a phase, modulo 2π, which is equal to substantially zero for one of the wavelengths. The zone widths, and step heights, are chosen to provide a desired compensation of aberrations for the two other wavelengths.

In the NPS, the zone heights hⱼ (the height of zone j above the base surface of the substrate) are designed to be equal to:

$${h}_{j} = {m}_{j} \frac{λ}{n - 1}$$

where mⱼ is an integer, referred to herein as the step index, λ is the wavelength and n₁ is the refractive index of the material from which the NPS is made, at that wavelength. The above equation is valid where the NPS interfaces with air; the interface could also be between two different materials, in which case the denominator becomes (n₁-n₂).

Thus, the zone heights differ by integral multiples (1, 2, 3, etc.) of a basic step height. Embodiments of the invention may make use of the basic step heights h_{BD}, h_{DVD} and h_{CD}. These are basic step heights selected according to equation (1) above, wherein mⱼ=1 and the appropriate wavelength λ, namely approximately 405 nm, 660 nm, 785 nm, and 405 nm respectively, is used.

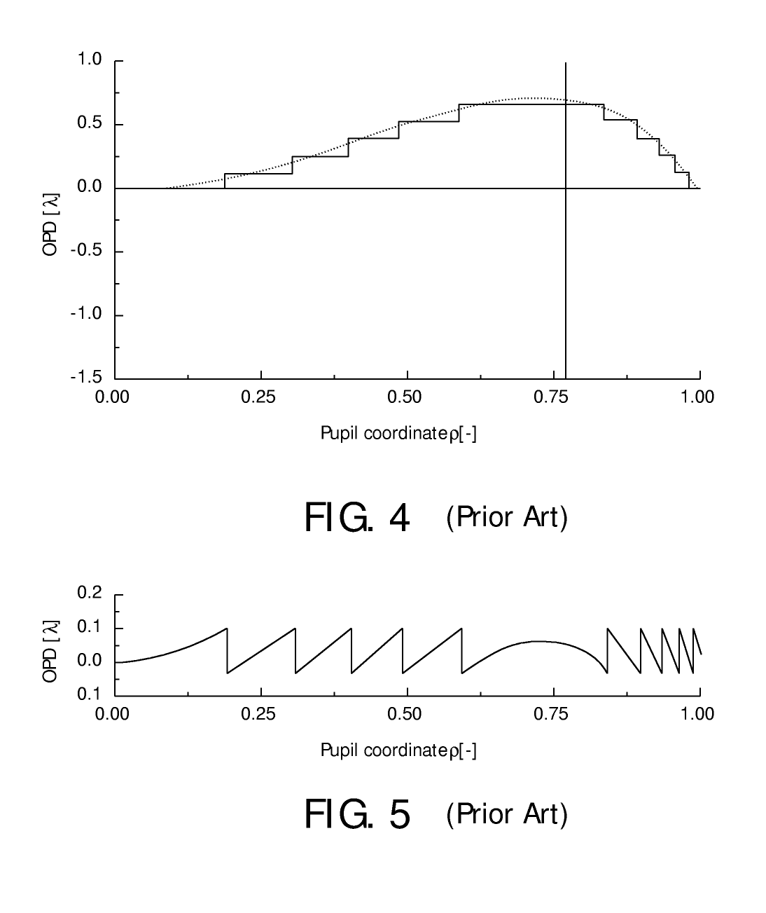

In the preferred embodiment of the invention, the objective system consists of a K-VC89 glass (Sumita) lens body with two lens zones. The first lens zone of the lens body is between NA=0.0 and NA=0.5. The second lens zone is between NA=0.5 and NA=0.85. The lens body has a thickness of 2.28 mm and the pupil radius at NA=0.5 is 1.17 mm. The region where the three wavelengths overlap (0.0<NA<0.5) is referred to as the central three-wavelength part of the objective, which will be discussed in further detail below. Note that in FIGS. 4 to 7, the “normalized pupil coordinate”, ρ, is normalized with respect to the width of the central three-wavelength part of the objective, not the entire pupil of the objective.

In this embodiment, the lens body is optimized for (i.e. designed to have, between the three wavelength modes, a minimum aberration (without the use of the corrector plate) in) the DVD mode, i.e. for wavelength λ₂. FIG. 3 illustrates the remaining optical path difference (OPD) in each of the CD, DVD and BD modes.

Because the lens body is optimized for DVD, the NPS, correspondingly, has step heights chosen to be multiples of the basic step height (in air) for DVD, namely h_{DVD}=1.170 μm. The available step heights, in multiples of the basic step height h_{DVD}, are set out in the Table below, along with their equivalent phase contribution Φ_{CD} and Φ_{BD}, in relation to the CD wavelength λ₁ and the BD wavelength λ₃, respectively.

TABLE

| Step Index | Height | Φ_{CD} | Φ_{BD} |
|---|---|---|---|
| (m) | (μm) | [waves] | [waves] |
| 1 | 1.170 | 0.833 | 0.730 |
| 2 | 2.340 | 0.666 | 0.460 |
| 3 | 3.511 | 0.499 | 0.190 |
| 4 | 4.681 | 0.332 | 0.919 |
| 5 | 5.851 | 0.165 | 0.649 |
| 6 | 7.021 | 0.998 | 0.379 |
| 7 | 8.191 | 0.831 | 0.109 |
| 8 | 9.362 | 0.664 | 0.839 |
| 9 | 10.532 | 0.497 | 0.569 |
| 10 | 11.702 | 0.330 | 0.299 |
| 11 | 12.872 | 0.163 | 0.028 |
| 12 | 14.043 | 0.996 | 0.758 |
| 13 | 15.213 | 0.829 | 0.488 |
| 14 | 16.383 | 0.662 | 0.218 |
| 15 | 17.553 | 0.494 | 0.948 |
| 16 | 18.723 | 0.327 | 0.678 |
| 17 | 19.894 | 0.160 | 0.408 |
| 18 | 21.064 | 0.993 | 0.138 |
| 19 | 22.234 | 0.826 | 0.867 |
| 20 | 23.404 | 0.659 | 0.597 |
| 21 | 24.574 | 0.492 | 0.327 |
| 22 | 25.745 | 0.325 | 0.057 |
| 23 | 26.915 | 0.158 | 0.787 |
| 24 | 28.085 | 0.991 | 0.517 |
| 25 | 29.255 | 0.824 | 0.247 |

FIG. 4 shows a plot of the optical path difference (OPD) of the remaining aberration for the CD mode is shown as a function of the normalized pupil coordinate for the prior art case, in which no focus error offset is used. The equivalent NPS design, according to the prior art, is shown, as a stepped structure illustrated with a solid line, which is capable of compensating both the CD OPD and the BD OPD, as illustrated in FIG. 3, in each zone of the NPS. Referring to the Table above, the step heights used are step heights in which the step indices m=5, m=10, m=15, m=20 and m=25 are used. In this arrangement, the maximum NPS step height is approximately 29.3 μm. At this height the NPS introduces a phase of 0.69λ, which is relatively large.

FIG. 5 shows the remaining OPD in CD mode after correction with an NPS according to the prior art. Whilst the equivalent phase contribution Φ_{CD} and Φ_{BD} of the steps is appropriate to compensate the spherical aberration in both the CD and BD modes, the zone heights are relatively large. Due to the relatively high zone heights necessary, the NPS is highly sensitive to wavelength changes, which is undesirable.

FIG. 6 shows a plot of the optical path difference (OPD) of the remaining aberration for the CD mode as a function of the normalized pupil coordinate for the present invention, in which a focus error offset is used in the CD mode. The equivalent NPS design is shown, as a stepped structure illustrated with a solid line, which is capable of compensating both the CD OPD and the BD OPD, as illustrated in FIG. 3, in each zone of the NPS. Referring to the Table above, only a single zone is used in the region 0.0<ρ<0.77, and the step height used is a single step height in which the step index m=5 is used. Note that, outside the region 0.0<ρ<0.77, the phase contributions required by zones, which are represented by the dotted line, can be provided using relatively small NPS steps, as illustrated by the solid stepped line in this region. In this outer region, an annular wavelength-selective (i.e. dichroic) blockage is used to block out the radiation at the BD wavelength, λ₃, resulting in a greater freedom of design and allowing relatively small step heights, namely those having step indices m=1, m=2, m=3, m=4 and m=5, to be used in order to provide aberration compensation for the CD mode alone.

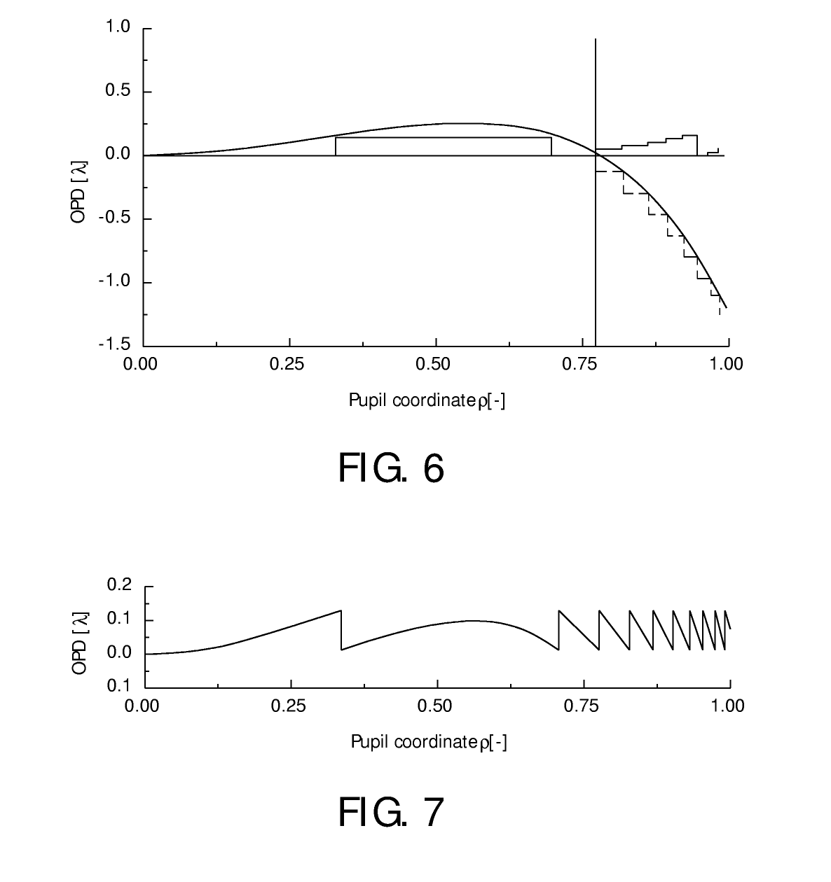

FIG. 7 shows the remaining OPD in CD mode after correction with an NPS according to this embodiment of the invention. In the region 0.0<ρ<0.77, the equivalent phase contribution Φ_{CD} and Φ_{BD} of the single step is appropriate to compensate the spherical aberration in both the CD and BD modes. Outside this region, a dichroic annular blockage is used to block out the radiation at the BD wavelength, λ₃, and the NPS is used to correct the aberrations in the CD mode alone. The zone heights can therefore be relatively small, and the NPS is less sensitive to wavelength changes, which is desirable.

To reduce the NPS step height, during design of the optical objective lens an offset is added to the focus distance in the CD mode only. This focus offset is used to ensure that the lens distance between the lens and disc is reduced, relative to the fully focused state, in this embodiment by 7.25 μm, as a result of which the objective is defocused. More generally, the focus offset is preferably at least 2 μm, and more preferably at least 5 μm.

As a result only one NPS zone in the region 0.0<ρ<0.77 is needed with a height of 5.85 μm. Outside this region the BD radiation is be blocked by a dichroic aperture so that the NPS has to correct the OPD for CD only. In this way the NPS step heights for ρ>0.77 can be smaller or equal to 5.85 μm.

The new defocused design has a much smaller wavelength dependence (approximately 5 times) at a cost of only 20% radiation in the BD mode that is blocked by the aperture.

Embodiments of the invention provide objective systems for optical scanning devices whereby the central part of the radiation beam path is corrected for three wavelengths, compatible with formats of disc which require scanning using all NAs, including the highest NA (typically that with the lowest wavelength of radiation) using NPS structures. In the above, the discussion is limited to the central part of the lens, referred to as the three-wavelength part. However, it should be understood that the embodiments described include structures and/or lens faces, which render the respective parts of the objective compatible with formats of disc, which require scanning using the outer part of the objective lens.

For the area immediately outside this central part of the lens the problem reduces to a two wavelength problem followed by a one wavelength problem, solved by use of a two wavelength part outside the three wavelength part and a one wavelength part outside the two wavelength part. Commonly known solutions exist for both a two-wavelength part and a one-wavelength part. For the two wavelength part the corrector plate can be designed to include an NPS in the two wavelength part such as that described in the article “Application of non-periodic phase structures in optical systems” referred to above, the relevant contents of which are incorporated herein by reference, so as to provide appropriate compensation for the two relevant wavelengths. For the one wavelength part the objective lens itself, or the corrector plate, can be designed to be compensated using a continuous aspherical lens surface in the one wavelength part for the remaining wavelength.

The above embodiments are to be understood as illustrative examples of the invention. Further embodiments of the invention are envisaged.

In the above embodiments, an optical compensator is provided in the form of an NPS structure on a corrector plate, which is separate from the objective lens. It should be noted that the NPS structure could also be placed directly on the lens body. In this case, the base surface of the substrate follows a lens surface shape, generally an aspherical surface shape, and the NPS structure is formed as a height variation with reference to the lens surface shape as the base profile. A lens with such an NPS may for example be made of a photopolymer (2P) replica material formed by a moulding process on a spherical surface of a glass substrate. The replica material may provide both the surface variation from the spherical glass surface to form the aspherical lens base profile and the NPS structure formed on top of the base profile.

Furthermore, an optical compensator according to the invention may be provided in the form of two separate elements, for example two different NPS structures on two separate corrector plates spaced along the optical axis of the optical system, or two NPS structures provided on opposite sides of a single corrector plate, the two NPS structures in either case having a combined effect which is similar to the single NPS structures described above.

Further, while the above embodiments describe compensation provided only in the form of an NPS structure, the optical compensator may also, or alternatively, include one or more diffractive structures providing focusing and/or aberration compensating functions.

Embodiments described above relate to a BD, CD and DVD compatible objective system; however, the invention can be applied to other multi-wavelength systems. Further, the invention is not limited to a three-wavelength system but can also be applied to systems using more wavelengths.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An optical scanning device for scanning optical record carriers, the optical record carriers including a first optical record carrier, a second optical record carrier and a third optical record carrier, the scanning device including a radiation source system (7) for producing first, second and third radiation beams for scanning said first, second and third record carriers, respectively, in first, second and third scanning modes, said first, second and third radiation beams having different predetermined wavelengths,
the scanning device comprising an objective lens and an optical compensator,
the optical compensator having a non-periodic phase structure through which each of said first, second and third radiation beams are arranged to pass, said non-periodic phase structure including a plurality of stepped annular zones separated by steps, the zones forming a non-periodic radial pattern, the stepped annular zones introducing first, second and third different wavefront modifications into at least part of the first, second and third radiation beams, respectively,
characterized in that said objective lens is arranged to apply a focus offset when scanning said first record carrier, which focus offset is arranged to provide a phase modification which, in combination with said optical compensator, compensates spherical aberration in the first radiation beam.

2. An optical scanning device according to claim 1, wherein the wavelength of said third radiation beam is shorter than the wavelength of said second radiation beam and the wavelength of said second radiation beam is shorter than the wavelength of said first radiation beam.

3. An optical scanning device according to claim 2, wherein said wavelengths of said first, second and third radiation beams are approximately 785, 660 and 405 nanometres, respectively.

4. An optical scanning device according to claim 1, wherein the heights of the annular zones are selected such that the optical compensator is substantially invisible to the wavelength of said second radiation beam.

5. An optical scanning device according to claim 1, wherein said scanning device includes a wavelength-selective blockage for preventing a part of said third radiation beam, which is inside a further part which is transmitted towards the third record carrier, from reaching the third record carrier.

6. An optical scanning device according to claim 5, wherein said blockage is an annular blockage.

7. An optical scanning device according to claim 1, wherein said first, second and third record carriers each have information layer depths, which are substantially different.

8. An optical scanning device according to claim 7, wherein said first, second and third record carriers have information layer depths which are approximately 1.2, 0.6 and 0.1 millimetres, respectively.

9. An optical scanning device according to claim 1, wherein said optical compensator is provided in the form of an optical corrector plate to be provided separate from an objective lens for said optical scanning device.

10. An optical scanning device according to claim 1, wherein said optical compensator is provided on the surface of an objective lens for said optical scanning device.

11. An optical scanning device according to claim 1, wherein said focus offset is applied selectively in one, or more, of said first, second and third scanning modes.

12. An optical scanning device according to claim 11, wherein said focus offset is applied in said first scanning mode, and not in either said second scanning mode or said third scanning mode.
